(19) United States
(12) Patent Application Publication
(10) Pub. No.: US 2005/0159989 A1
(43) Pub. Date: Jul. 21, 2005

(54) Method and apparatus of managing product for recycle planning

(76) Inventors: Takashi Tsuno, Yokohama (JP); Kazuyuki Bunai, Kamakura (JP); Toshiyasu Iljima, Yokohama (JP); Yuichi Kaneko, Yokohama (JP); Toshiyuki Sakuma, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 10/992,694

(22) Filed: Nov. 22, 2004

(30) Foreign Application Priority Data
Dec. 4, 2003 (JP) 2003-406281
Sep. 27, 2004 (JP) 2004-279500

(51) Int. Cl. G06F 17/60; C10M 175/00

(52) U.S. Cl. 705/7

(57) ABSTRACT

A profit of a product using a recycled component is calculated and presented in an actual production plan. Developed and stored beforehand in a memory of a computer are: cost data involved in disassembling a recycled product and manufacturing a new product, including a component unit price, an assembly cost, a disassembly cost, a collection cost, an inspection cost, a washing cost and a maintenance cost; data of a production plan; and data of the component constitution of a product. A user inputs information of the recycled product from a client and a recycle condition. The computer determines a disassembly point of components of a collected product in accordance with input information and the data of the component constitution of the product. A profit of the product using the recycled component is calculated from the determined disassembly point, the data of the production plan and the cost data.

INCORPORATION BY REFERENCE

The present application claims priorities from Japanese applications JP2003-406281 filed on Dec. 4, 2003, JP2004-279500 filed on Sep. 27, 2004 the contents of which are hereby incorporated by reference into this application.

### BACKGROUND OF THE INVENTION

The present invention relates to a recycle supporting method and system, and more particularly to a recycle supporting method and system suitable for use with the product manufacture by reusing components obtained by disassembling a collected product, as recycled components.

Problems such as an insufficient number of facilities for processing waste products and environment contamination by dumped products are becoming serious nowadays, and recycling of waste products has been paid attention. Known conventional technologies regarding waste product recycling are described, for example, in JP-A-09-160959, JP-A-2002-230087, and JP-A-2002-259553.

These conventional technologies pertain to a product design method which considers the facilitation and economical efficiency of recycling collected waste products, and an evaluation method for evaluating an economical efficiency of reusing recycled products, a saving of energy consumption in recycle processing, a reduction in waste materials, a prevention of environment contamination and the like.

### SUMMARY OF THE INVENTION

In order to reduce the manufacture cost of a product using recycled components and obtain a larger profit, it is desired to consider how collected products are disassembled to use recycled components, while recycle regulations and rules are obeyed.

An object of the present invention is to provide a recycle supporting method and system capable of calculating and presenting a largest profit to be obtained by using recycle components of a collected product having a hierarchical structure of components, while recycle regulations and rules are obeyed.

The above object of the present invention can be achieved by: preparing data of costs required for the disassembly of a collected product and the manufacture of a product using recycled components, including a component unit price, an assembly cost, a disassembly cost, a collection cost, an inspection cost, a washing cost, and a maintenance cost, data of a production plan, data of the component constitution of a product; determining a disassembly point of a component of a collected product in accordance with input collected product information and recycle conditions, and the data of the component constitution of the product; and calculating a profit to be obtained by the manufacture of the product using recycled components in accordance with the determined disassembly point, the production plan data and the cost data; and presenting the profit.

According to the present invention, it is possible to calculate and present a profit by using recycled components under obedience to regulations, in an actual production plan.

### BRIEF DESCRIPTION OF THE DRAWINGS

FIG. 1 is a diagram illustrating a flow of recycling for manufacturing a product by disassembling a waste product and reusing recycled components.

FIG. 2 is a diagram showing the structure of master data of sales prices.

FIG. 3 is a diagram showing the structure of master data of component unit prices.

FIG. 4 is a diagram showing the structure of master data of assembly costs.

FIG. 5 is a diagram showing the structure of master data of disassembly costs.

FIG. 6 is a diagram showing the structure of master data of product collection costs.

FIG. 7 is a diagram showing the structure of master data of component inspection costs.

FIG. 8 is a diagram showing the structure of master data of component washing costs.

FIG. 9 is a diagram showing the structure of master data of component maintenance costs.

FIG. 10 is a diagram showing the structure of master data of the quantity of each product according to a production plan.

FIG. 11 is a diagram showing the structure of master data registering the weight of a product/component.

FIG. 12 is a diagram showing the structure of master data setting a product sales price and a multiplication factor of an increase in the number of sold products, when recycle components are used for the product.

FIG. 13 is a diagram showing the structure of master data defining defective factors of a collected product and each component obtained from the product.

FIG. 14 is a diagram showing an example of a screen for selecting a product, the screen being displayed initially when the system is started up.

FIG. 15 is a diagram showing an example of a condition input screen for entering the condition of calculating a disassembly point (indicating that the components are disassembled to what hierarchical level).

FIG. 16 is a diagram showing an example of a disassembly point selection screen.

FIG. 17 is a diagram showing an example of a component (quantity) selection screen.

FIG. 18 is a diagram showing an example of a disassembly point (price) selection screen.

FIG. 19 is a diagram showing an example of a screen showing a list of products using recycled components.

FIG. 20 is a flow chart illustrating the summary of a process of calculating a profit to be obtained by manufacturing a product using recycled components.

FIG. 21 is a flow chart illustrating an operation of obtaining a product using recycled components, disassembling the product to the disassembly point and calculating costs involved in making the components be able to be recycled, respectively at Step 201 shown in FIG. 20.

FIG. 22 is a flow chart illustrating an operation of calculating manufacture costs of a product using recycled components or using the same new components as the recycled components, at Step 202 shown in FIG. 20.

FIG. 23 is a flow chart illustrating an operation of calculating a total profit of a product using recycled components or using the same new components as the recycled components, at Step 203 shown in FIG. 20.

FIG. 24 is a flow chart illustrating an operation of calculating a profit of a product not using recycled components or having the same new components as the recycled components in the component structure, at Step 204 shown in FIG. 20.

FIG. 25 is a diagram showing an example of a screen showing a list of profit results of candidate products calculated by the embodiment process.

FIG. 26 is a diagram showing an example of a screen to be displayed when one candidate is selected from the list shown in FIG. 25 and a detail button is depressed.

FIG. 27 is a diagram showing a model specifically illustrating the calculation of a profit when a product is manufactured by using recycled components obtained through disassembly of a waste product.

FIG. 28 is a block diagram showing the structure of a recycle supporting system realizing a recycle supporting method according to the embodiment.

### DESCRIPTION OF THE EMBODIMENTS

With reference to the accompanying drawings, detailed description will be made on a recycle supporting method and system according to an embodiment of the present invention.

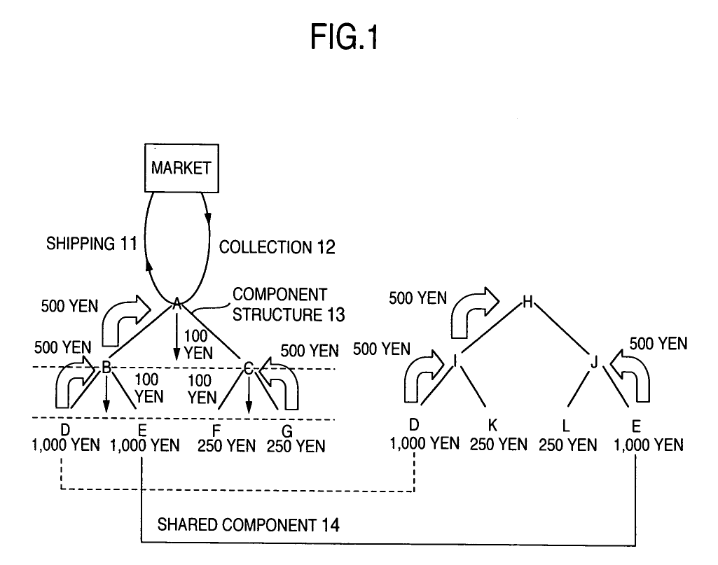

FIG. 1 is a diagram illustrating the principle of a recycle flow of manufacturing a product by disassembling a waste product and reusing obtained components, according to the embodiment. First, the principle of the recycle flow will be described.

In the general waste recycling, a manufacturer collects products from markets, each collected product is disassembled to a predetermined disassembly point (indicating the hierarchical level to which components generally having the hierarchical level are disassembled), each disassembled component is inspected whether it can be recycled, the usable component is washed and is assembled as a component recycled to a product to be newly manufactured.

In the example shown in FIG. 1, a product A is shipped to a market via a shipping route 11 and returned to a shipping agent (manufacturer) via a collection route 12. As shown as a component constitution 13 of a tree structure in FIG. 1, the product A is generally manufactured by assembling a plurality of components. These components have each its own unit price, and costs such as assembly costs and disassembly costs. The product A in the example shown in FIG. 1 is assumed to be constituted of a composite component B made of components D and E and a composite component C made of components F and G. The following assumptions are also made. The unit prices of the components D to G are 1,000 Yen, 1,000 Yen, 250 Yen and 250 Yen, respectively. Costs involved in disassembling the product A into the composite components B and C are 100 Yen. Costs involved in disassembling the composite components B and C into the components D and E and the components F and G, respectively, are 100 Yen. Costs involved in assembling the components D and E and the components F and G into the composite components B and C, respectively, are 500 Yen.

If there is another product which can be manufactured by using the recycled components, the components obtained from the product A can be recycled. FIG. 1 shows that the components D and E can be used as shared components 14 to manufacture the products A and H. Namely, the product H can be manufactured by using a composite component I made of the component D and a component K and a composite component J made of a component L and the component E. In the example shown in FIG. 1, the product H is manufactured by using the recycled components and new components, and the unit price of each component and assembly costs are shown. The product H is also collected after its use in the market is finished, and disassembled into components to be recycled. As described above, shared components to be used in common by a plurality of products exist among components obtained by disassembling a product. It is assumed that there are such components, i.e., in the example of FIG. 1, the components D and E, capable of being used in common by a plurality of products. In this case, if the collected product A is disassembled only into the composite component B, this composite component B can be assembled only to the product A as the recycled component. However, if the product A is disassembled further into the components D and E, these components D and E can be assembled to not only the product A but also the product H. This is considered when the disassembly point is calculated.

A list of components is calculated which components fulfil a use obligation of recycled components stipulated by laws, rules and the like, such as an obligation of using recycled components 10% or more, i.e., 10%≦(weight of recycled components/weight of A). A profit is calculated and presented which can be obtained if the components in the list are used as recycled components. The use obligation is, for example, as described above, an obligation of using, as recycled components, the components having a weight 10% or more relative to the total weight of the product A. In order to fulfil such obligation or condition, it is calculated in such a manner that the composite component B or the components D and E are used as the recycled components among those components obtained by disassembling the product A. Further, a profit obtained by reusing these components is calculated. For example, a profit of one million Yen can be obtained if the composite component B obtained by a certain number of products A, or a profit of two millions Yen can be obtained if the components D and E are recycled.

In order to realize the above-described functions of this embodiment, it is necessary to form a variety of master data. The structures of a variety of master data will be described next.

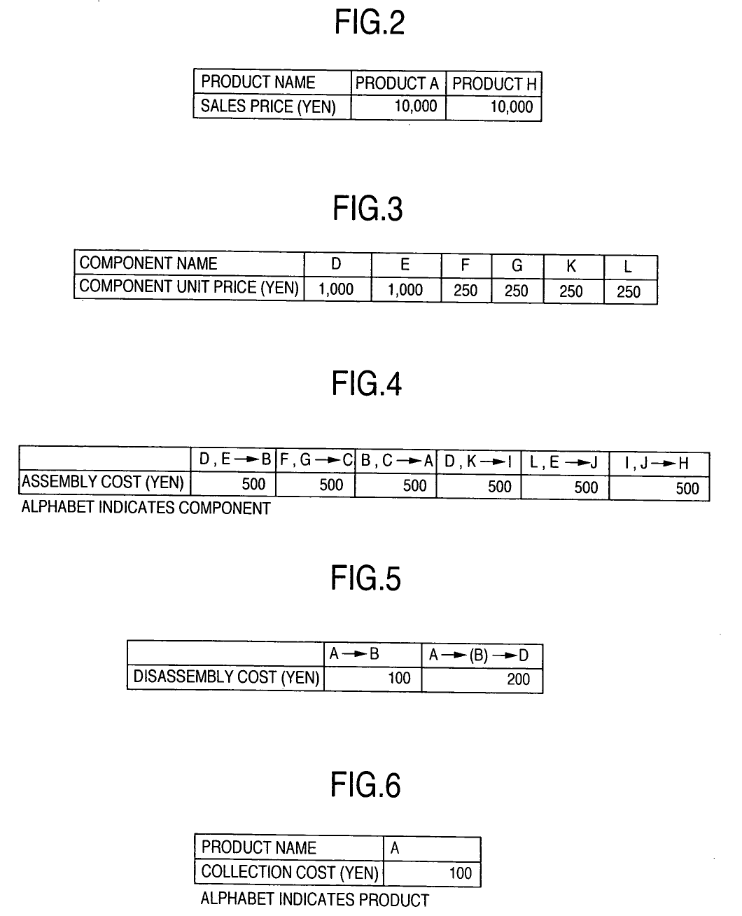

FIG. 2 is a diagram showing the structure of master data of sales prices. The master data of sales prices is the data indicating a sales price of each manufactured product. In FIG. 2, the sales price of each of the products A and H is 10,000 Yen. The master data of sales prices may be formed for a number of products.

FIG. 3 is a diagram showing the structure of master data of component unit prices. The master data of component unit prices is the data indicating a unit price of each component necessary for manufacturing a product. FIG. 3 shows the unit prices of the components D to G, K and L at the lowermost level shown in FIG. 1. The master data of unit prices may be formed for a number of components.

FIG. 4 is a diagram showing the structure of master data of assembly costs. The master data of assembly costs is the data setting a cost involved in assembling components to a component or product at one upper level. FIG. 4 shows the costs involved in assembling the components at the lowest level shown in FIG. 1 to the composite components and assembling the composite components to the products. The master data of assembly costs may be formed for a number of combinations of components to be assembled. The master data of an assembly cost may be formed which cost is involved in assembling a plurality of composite components to a larger composite component.

FIG. 5 is a diagram showing the structure of master data of disassembly costs. The master data of disassembly costs is the data setting a cost involved in disassembling a product into a target component. FIG. 5 shows the costs involved in disassembling the product A shown in FIG. 2 into the composite component B and involved in disassembling the product A into the component D via the composite component B. The master data of disassembly costs may be formed for a number of combinations of disassembly processes.

FIG. 6 is a diagram showing the structure of master data of product collection costs. The master data of product collection costs is the data setting a cost involved in collecting each product from a market. Although FIG. 6 shows only the collection cost of the product A, the master data of product collection costs is set for a number of products if a plurality type of products are collected and used.

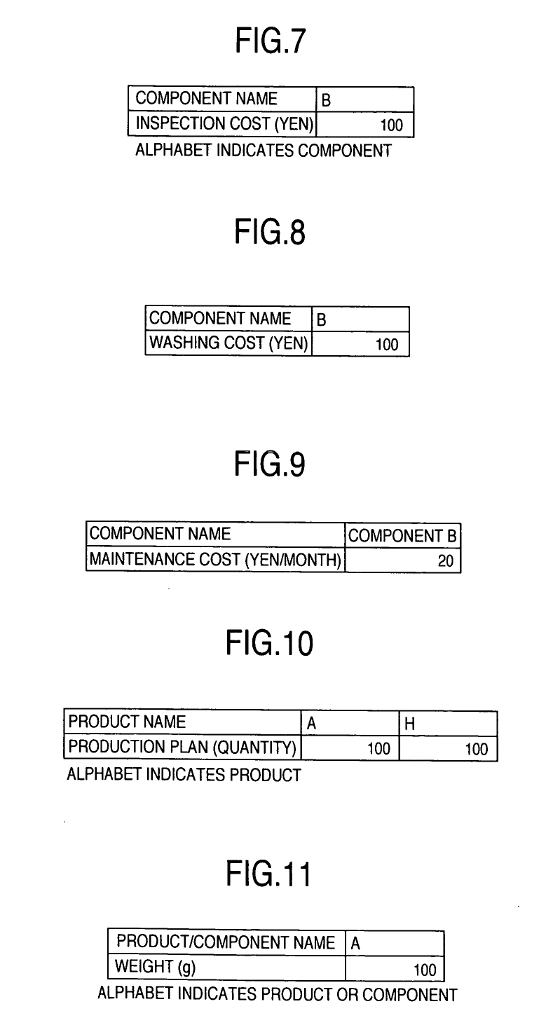

FIG. 7 is a diagram showing the structure of master data of component inspection costs. The master data of component inspection costs is the data setting a cost involved in inspecting each component obtained by disassembling a collected product to be recycled. Although FIG. 7 shows only the inspection cost of the component B, the master data of component inspection costs is set for all components obtained from a collected product.

FIG. 8 is a diagram showing the structure of master data of component washing costs. The master data of component washing costs is the data setting a cost involved in washing each component obtained by disassembling a collected product to be recycled. Although FIG. 8 shows only the washing cost of the component B, the master data of component washing costs is set for all components obtained from a collected product.

FIG. 9 is a diagram showing the structure of master data of component maintenance costs. The master data of component maintenance costs is the data setting a cost involved in maintaining each component necessary for holding it in a warehouse or the like until the component obtained by disassembling a collected product is recycled. Although FIG. 9 shows only the maintenance cost of the component B, the master data of component maintenance costs is set for all components obtained from a collected product.

FIG. 10 is a diagram showing the structure of master data of the quantity of each product according to a production plan. The master data of the quantity of each product according to the production plan is the data setting the quantity of each product to be manufactured. FIG. 10 shows the production quantities of the products A and H shown in FIG. 1. If other products are to be manufactured, the production quantities of these products are also set to the master data.

FIG. 11 is a diagram showing the structure of master data of product/component weights. The master data of product/component weights is the data setting a weight of a product to be collected and a weight of each component obtained by disassembling the collected product. Although FIG. 11 shows only the weight of the product A, the master data of product/component weights is set for all products to be collected and for all components obtained from collected products.

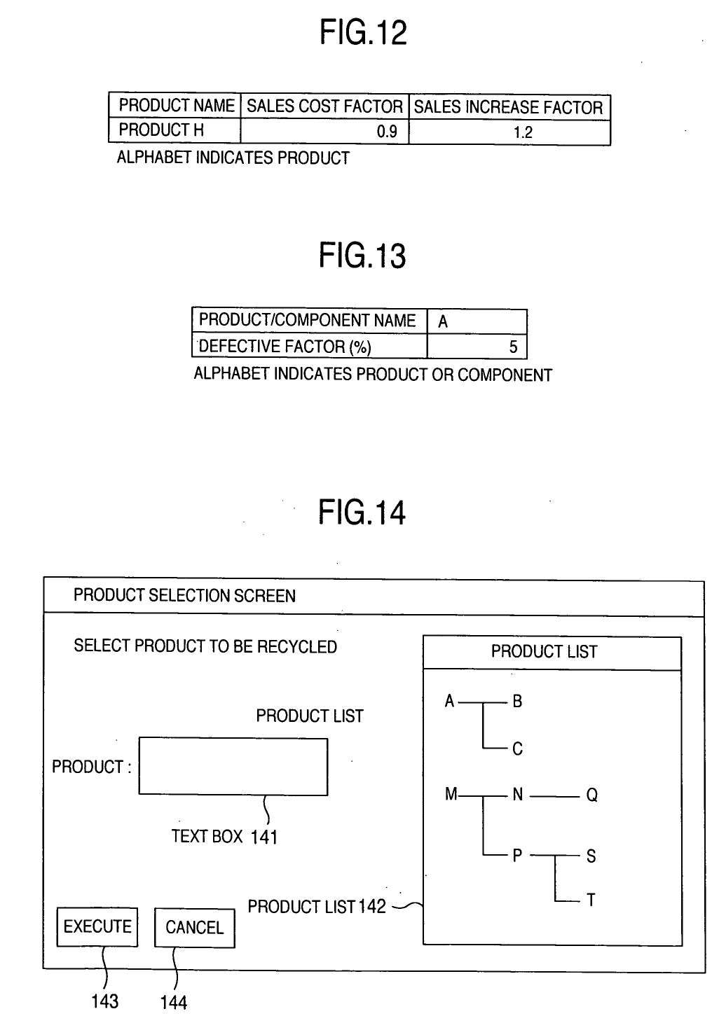

FIG. 12 is a diagram showing the structure of master data setting a product sales price and a multiplication factor of an increase in the number of sold products, when recycle components are used for the product. The master data setting a product sales price and a multiplication factor of an increase in the number of sold products is the data defining for each product a sales increase factor and a sales cost factor of the product using recycled components relative to the general product, i.e., the product manufactured by using only new components. Although FIG. 12 shows only the data of the product H, the master data is set for all products using recycled components.

FIG. 13 is a diagram showing the structure of master data defining defective factors of a collected product and each component obtained from the collected product. The master data defining defective factors is the data setting for each product and each component the defective factors of the product and component. Although FIG. 13 shows only the data of the product A, the master data is set for all collected products and all components obtained from the collected products.

In order to realize the functions of this embodiment, various screens are displayed after the system is started up, and a user is allowed to enter necessary data or the like on these screens. Next, the structure of each screen and input data or the like will be described.

FIG. 14 is a diagram showing an example of a screen for selecting a product, which screen is initially displayed when the system is started up.

The product selection screen shown in FIG. 14 is constituted of a text box 141 in which the name of a product to be collected as a recycle target product is input, a component list 142 for displaying the name of a product to be collected and the component configuretion in a tree shape, an execute button 143 and a cancel button 144. When this product selection screen is displayed, a number of product names along with their component constitutions are displayed in the component list 142. As a user selects the product displayed in the component list 142, the product name is displayed in the text box 141. The component constitution of each product displayed in the component list 142 is not required to be displayed completely. For example, as the user selects one of the displayed components, a component group at a lower level may be displayed. The product selected and displayed in the text box 141 is the collection target product from which recycle components are acquired. It may be structured in such as manner that a plurality of products can be selected. As the execute button 143 is clicked after the product is selected, the next screen is displayed, whereas the cancel button 144 is clicked, the process of this system is terminated without executing the process at the product selection screen.

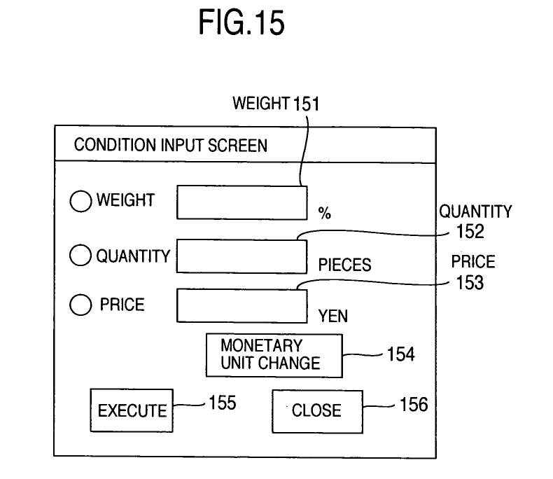

FIG. 15 is a diagram showing an example of a condition input screen for determining which is considered when the disassembly point (indicating that components are disassembled to what hierarchical level) is calculated. This condition input screen is displayed when the execute button on the screen shown in FIG. 14 is clicked.

In this embodiment, three conditions “weight”, “quantity” and “price” are used as the conditions of calculating the disassembly point. If the condition is the “weight”, % of the weight of a product is to be recycled is input to a weight text box 151. If the condition is the “quantity”, the number of components to be recycled is input to a quantity text box 152. If the condition is the “price”, a component unit price is input to a price text box 153. This component unit price is used to instruct the use of a component having a higher price than the input price, as a recycled component. A monetary unit change button 154 is used to change the unit of a money amount to be input to the price text box, and the unit can be changed to the monetary unit of each country. As an execute button 155 is clicked after the input of the condition is completed, the next screen is displayed, whereas as a close button 156 is clicked the process at the condition input screen is not executed and the screen returns to the product selection screen shown in FIG. 14.

Any one of the above-described conditions “weight”, “quality” and “price” is input, the profit is calculated under the input condition. Although a plurality of conditions may be input, the following description assumes only one condition.

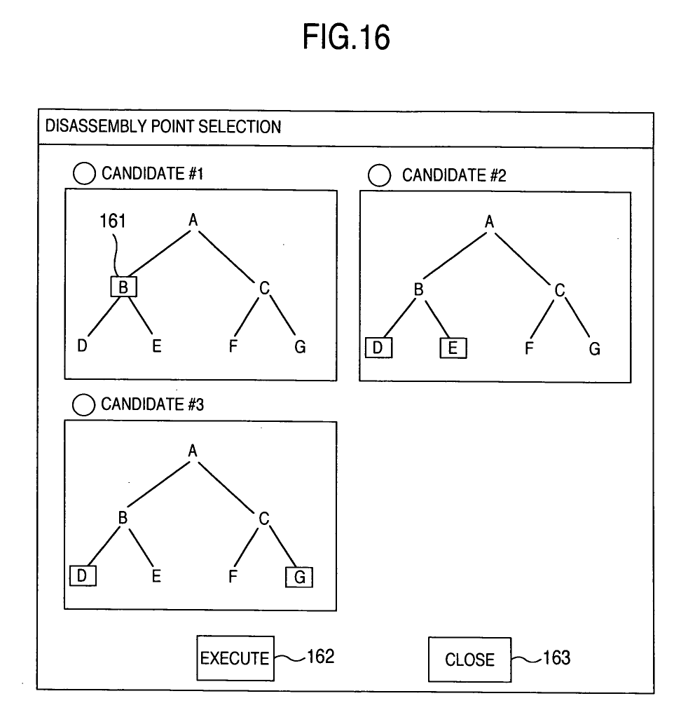

FIG. 16 is a diagram showing an example of a disassembly point selection screen. This disassembly point selection screen is displayed when % of the weight of a product is to be recycled is input to the screen shown in FIG. 15 as the condition and the execute button 155 is clicked.

The screen shown in FIG. 16 displays a plurality of candidates each including components satisfying the target weight and combinations thereof. Each candidate emphatically displays a component or components to be used as a recycle component or components. In the example shown in FIG. 16, a candidate #1 emphatically displays as indicated at 161 the composite component B, a candidate #2 emphatically displays the components D and E, and a candidate #3 emphatically displays the components D and G. The user selects one of a plurality of displayed candidates by entering a check in a circle displayed in front of the candidate name. As an execute button 162 is clicked thereafter, the next screen is displayed, whereas a close button 163 is clicked, the screen returns to the condition input screen shown in FIG. 15 without executing the process at the disassembly point selection screen.

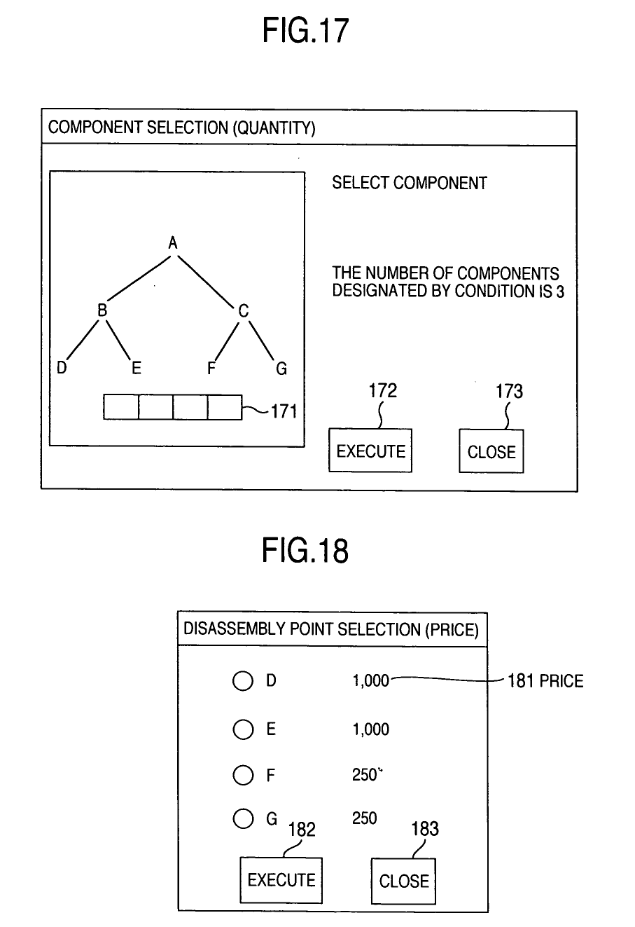

FIG. 17 is a diagram showing an example of a component selection (quantity) screen. This component selection screen is displayed when the quantity of components to be recycled from a collected product is input as the condition to the screen shown in FIG. 15 and the execute button 155 is clicked.

If the numeral is input to the quantity text box 152 on the screen shown in FIG. 15, it is designated that how many components are used as recycle components among the components constituting the product to be collected. As in the screen example shown in FIG. 17, the designated number of components together with the component constitution of the product to be collected is displayed. The user selects the component (component to be recycled) which corresponds to an actual disassembly point. A text box 171 to which a selected component is input is provided in the box displaying the component constitution of the product to be collected. As the user designates a component from the component constitution, the component name is input to the text box 171. The selected component is emphatically displayed in the tree. As the user clicks an execution button 172, the next screen is displayed, whereas as a close button 173 is clicked, the screen returns to the condition input screen shown in FIG. 15 without executing the process at the component selection screen.

The component quantity may be counted as one component even for the composite component. The component quantity may be the number of components at the lower levels, and if a composite component is selected, the component quantity may be the number of components at lower levels included in the composite component. These conditions are determined in advance.

FIG. 18 is a diagram showing an example of a disassembly point selection (price) screen. This disassembly point selection screen is displayed when the price of the component to be recycled from the collected product is input to the screen shown in FIG. 15 as the condition and the execute button 155 is clicked.

If the “price” is input to the screen shown in FIG. 15, the screen displaying components in the order of price is displayed as shown in FIG. 18, and only the components having a price higher than the price input to the screen shown in FIG. 15 are displayed. A price 181 is displayed to the right of the component name. The user selects the component to be used as a recycled component by inputting a check in a circle in front of the component name. In this case, a plurality of components may be selected. As an execute button 182 is clicked, the next screen is displayed, whereas as a close button 183 is clicked, the screen returns to the condition input screen shown in FIG. 15 without executing the process at the disassembly point selection (price) screen.

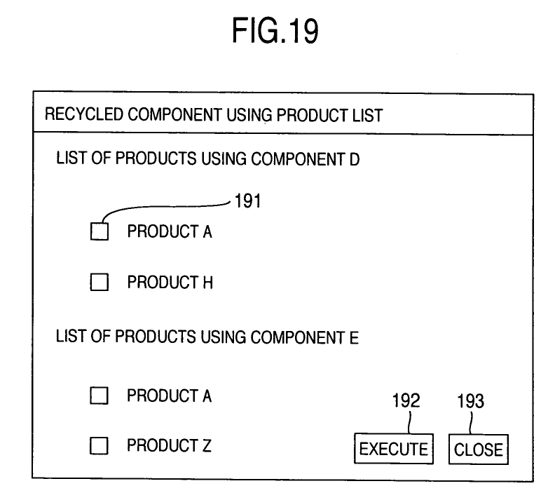

FIG. 19 is a diagram showing an example of a list screen of products using recycled components. This list screen of products using recycled components displays a list of products which can use the components to be recycled and determined by the above-described input operations.

In the example described above, since the product A is collected, the list screen of products using recycled components indicates that the products using the component D obtained from the product A to be collected are the products A and H and that the products using the component E obtained from the product A to be collected are the products A and Z. The user selects the product to be manufactured, by checking a check box 191. The component obtained from the collected product is assembled to the product selected by the check box 191. The sales figure of even the product not checked is used when the profit is calculated. This is because a profit difference is evaluated between the product checked and the product not checked, i.e., between the product assembled with the recycled component and the product assembled with the new component. As an execute button 192 is clicked after the product to be manufactured is selected, the process to be described next starts, whereas a close button 193 is clicked, the screen returns to the preceding screen without executing the next process.

In this embodiment, the number of products to be collected is calculated by considering any product judged defective by inspection. In calculating the number of products to be collected, the following equation is used by considering any defective product.

The number of products to be collected by considering a defective factor=(product production plan quantity)×(1/(1−(defective factor/100)))

After the component to be recycled is selected and the product which uses the recycled component is selected, from the above-described display screens, the following process of this embodiment is executed.

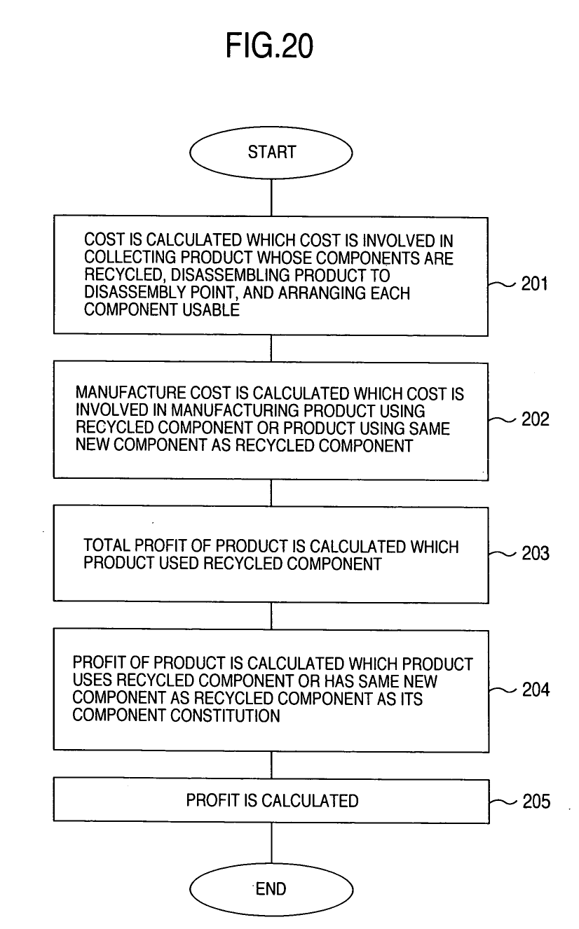

FIG. 20 is a flow chart illustrating the outline of the process of calculating a profit to be obtained by manufacturing a product using a recycled component, according to the embodiment.

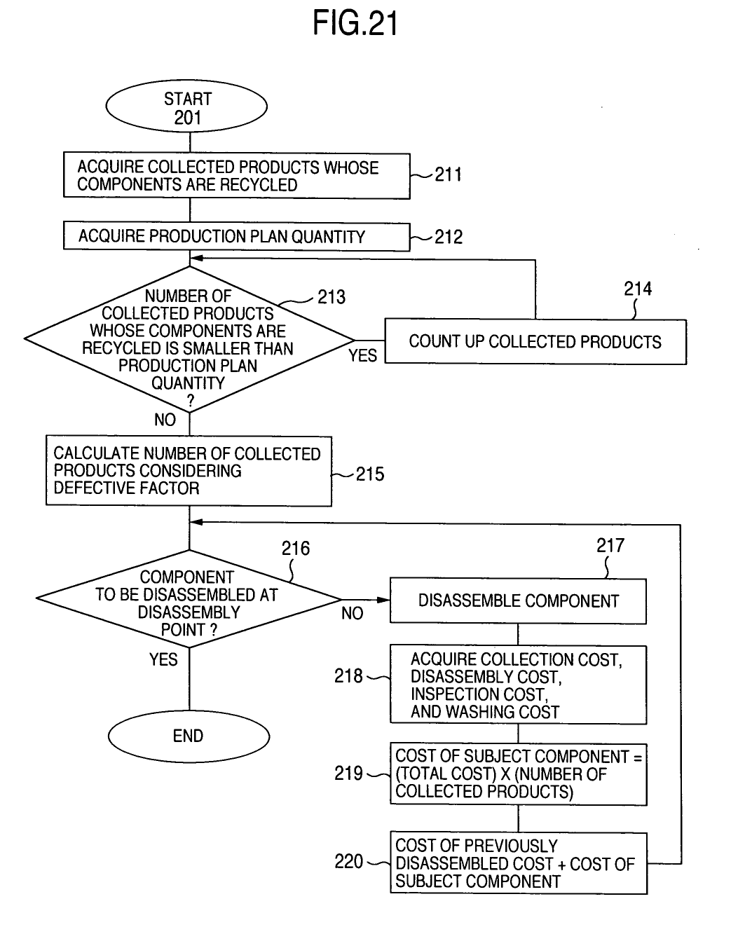

(1) A cost is calculated which cost is involved in collecting a product whose components are recycled, disassembling it to the disassembly point, and arranging each component to be usable (Step 201). The details of this process will be described with reference to the flow chart of FIG. 21.

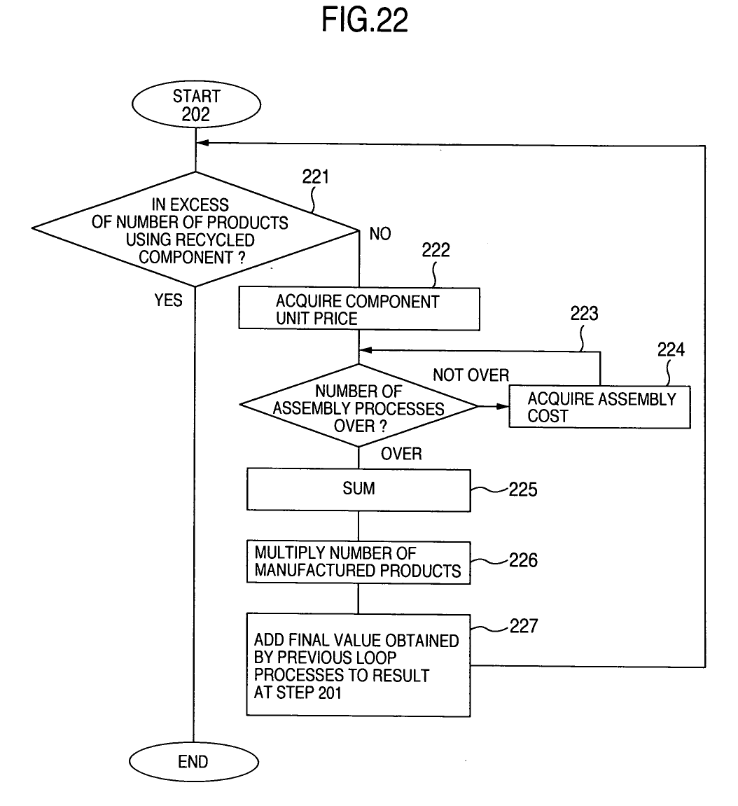

(2) A manufacture cost is calculated which cost is involved in manufacturing a product using a recycled component or a product using the same new component as the recycled component (Step 202). The details of this process will be described with reference to the flow chart of FIG. 22.

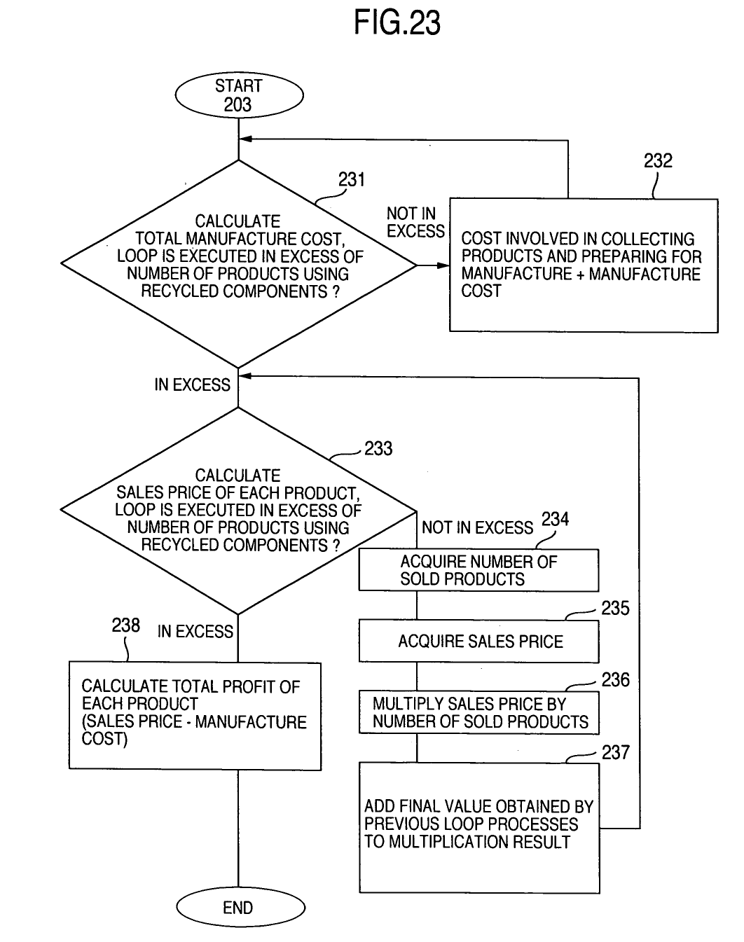

(3) A total profit of the product is calculated which product uses a recycled component (Step 203). The details of this process will be described with reference to the flow chart of FIG. 23.

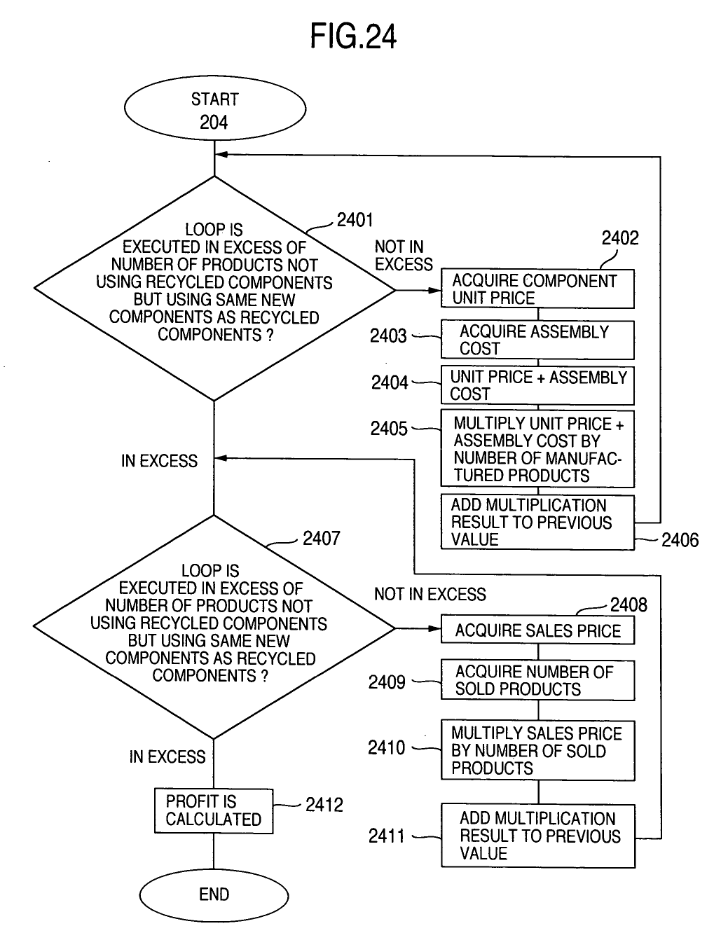

(4) A profit of the product is calculated which product uses a recycled component or has the same new component as a recycled component as its component constitution (Step 204). The details of this process will be described with reference to the flow chart of FIG. 24.

(5) Lastly, the final profit calculating process is executed to terminate the whole process (Step 205).

FIG. 21 is a flow chart illustrating the operation, at Step 201 of FIG. 20, of calculating a manufacture cost involved in manufacturing a product using a recycled component or a product using the same new component as the recycled component. This operation will be described.

(1) Acquired first are all products, which are selected in FIG. 19 and manufactured by using recycled components, and the production plan quantities (Steps 211 and 212).

(2) It is judged whether the number of collected products whose components are recycled is smaller than the production plan quantities. If smaller, the number of collected products is counted up to repeat the judgement. In this process, the number of collected products necessary for each product to be manufactured is counted, and this process is repeated until the collected products becomes corresponding in number to the total of these counts (Steps 213 and 214).

(3) If it is judged at Step 213 that the number of collected products whose components are recycled is larger than the production plan quantity, the number of collected products is counted again by considering the defective factor shown in FIG. 13. In calculating the number of collected products, the above-described equation is used:

The number of products to be collected by considering a defective factor=(product production plan quantity)×(1/(1−(defective factor/100)))

(4) The collected product is disassembled to the assembly point one hierarchical level after another of the component constitution, and it is judged whether the recycle components are disassembled to the disassembly point or not. If not, the recycle components are further disassembled, and the collection cost, disassembly cost, inspection cost and washing cost for each collected product are acquired from the data shown in FIGS. 6, 5, 7 and 8 (Steps 216 to 218).

(5) The cost of the disassembled subject component is calculated by multiplying the cost acquired at Step 210 by the number of collected products. This cost is added to the cost of previously disassembled components to thereafter return to Step 216 (Steps 219 and 220).

(6) If it is judged at Step 216 that the recycle components are disassembled to the disassembly point, i.e., if the component disassembled at Step 217 is at the disassembly point and the cost is calculated, then the flow terminates, whereas if the component to be disassembled is not at the disassembly point, it is disassembled at Step 217.

FIG. 22 is a flow chart illustrating the operation, at Step 202 of FIG. 20, of calculating a manufacture cost involved in manufacturing a product using a recycled component or a product using the same new component as the recycled component.

(1) A manufacture cost is calculated for each product using a recycled component. This process is therefore a loop of executing it the number of products using the recycled component, and is terminated when the number exceeds the number of products using the recycled component (Step 221).

(2) A loop of assembling components at a lower level to assemble a component at a higher level toward the final product is executed the number of assembly processes. An assembly cost at each assembly process is acquired from the data shown in FIG. 4 and the component unit price is acquired from the data shown in FIG. 3 (Steps 222 to 224).

(3) The assembly cost at each process is multiplied by the number of processes to obtain the total cost which is then multiplied by the number of manufactured products. Then, the final value obtained by the previous loop processes via Step 221 is added to the result obtained at Step 201 to thereafter return to Step 221 (Steps 225 to 227).

FIG. 23 is a flow chart illustrating the operation, at Step 203 of FIG. 20, of calculating a total profit of the product using a recycled component.

(1) A manufacture cost for each product is calculated if there are a plurality of products using the recycled component. This process is therefore a loop of calculating the manufacture cost of each product until the loop is executed in excess of the number of products, and judges whether the loop is executed in excess of the number of products Step 231.

(2) If it is judged at Step 231 that the loop is not executed in excess of the number of products, the cost involved in collecting the product and arranging for the manufacture and obtained at the process at Step 201 of FIG. 20 (the process in the flow chart of FIG. 21) is added to the manufacture cost obtained at the process at Step 202 of FIG. 20 (the process in the flow chart of FIG. 22), to thereafter return to Step 231 (Step 232).

(3) If it is judged at Step 231 that the loop is executed in excess of the number of products, it means that the calculation of the manufacture cost of each of all products has completed. The sales price of each of the products is acquired to calculate the total sales price. This process is therefore a loop of calculating the sales price until the loop is executed in excess of the number of products, and judges whether the loop is executed in excess of the number of products (Step 233).

(4) If it is judged at Step 233 that the loop is not executed in excess of the number of products, the sales quantity of each product is acquired and its price is acquired from the data shown in FIG. 2. The sales quantity is multiplied by the price. The multiplied result is added to the final value obtained by the previous loop processes including Step 233 to thereafter return to the process at Step 233 (Steps 234 to 237).

(5) If it is judged at Step 233 that the loop is executed in excess of the number of products, it means that the total sales price of all products is calculated. Then, a difference between the sales price and the manufacture cost is calculated and the total profit of the products using the recycled components is calculated to terminate the process (Step 238).

FIG. 24 is a flow chart illustrating the operation, at Step 204 of FIG. 20, of calculating a profit of the product which uses a recycled component or has the same new component as a recycled component as its component constitution.

(1) A manufacture cost of each product is calculated, the product not using a recycled component but having the same new component as the recycled component at its component constitution. This is because the profit changes depending upon whether the new component or recycled component is used. If there is a plurality of products, the manufacture cost is calculated for each product. This process is therefore a loop of calculating the manufacture cost of each product until the loop is executed in excess of the number of products, and judges whether the loop is executed in excess of the number of products (Step 2401).

(2) If it is judged at Step 2401 that the loop is not executed in excess of the number of products, a component unit price of the product is acquired from the data shown in FIG. 3 and an assembly cost is acquired from the data shown in FIG. 4. The unit price is added to the assembly cost. The result is multiplied by the number of manufactured products. The multiplication result is added to the final value obtained by the previous loop processes including Step 2401, to thereafter return to the process at Step 2401 (Steps 2402 to 2406).

(3) If it is judged at Step 2401 that the loop is executed in excess of the number of products, it means that the manufacture cost of all products is calculated. Then, the sales price of each product is calculated, the product not using the recycled component but having the same new component as the recycled component as its component constitution. If there are a plurality of products, the sales price of each product is calculated. This process is therefore a loop of calculating the sales price of each product until the loop is executed in the number of products, and judges whether the loop is executed in excess of the number of products (Step 2407).

(4) If it is judged at Step 2407 that the loop is not executed in excess of the number of products, the sales price of the product is acquired from the data shown in FIG. 2 and the number of sold products is acquired, which are multiplied together. The multiplication result is added to the final value obtained by the previous loop processes including Step 2407, to thereafter return to the process at Step 2407 (Steps 2408 to 2411).

(5) If it is judged at Step 2407 that the loop is executed in excess of the number of products, it means that the total sales price of all products is calculated. Then, a difference of the sales price from the manufacture cost is calculated to calculate the total profit of the product not using the recycled component but using the same new component as the recycled component to thereafter terminate the process (Step 2412).

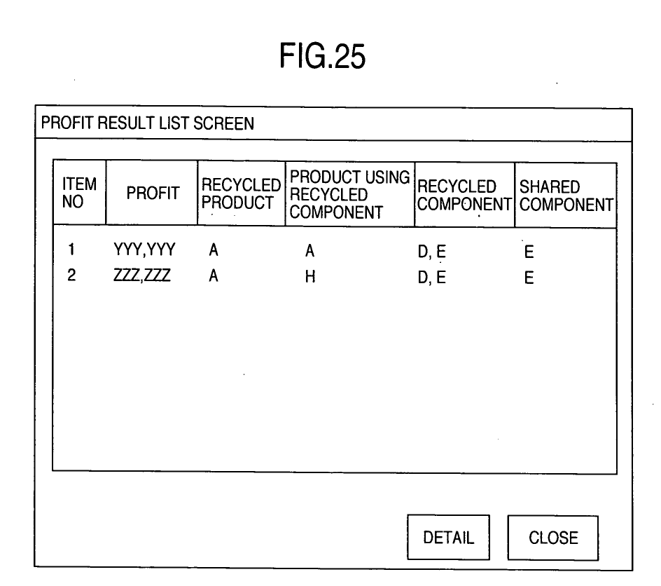

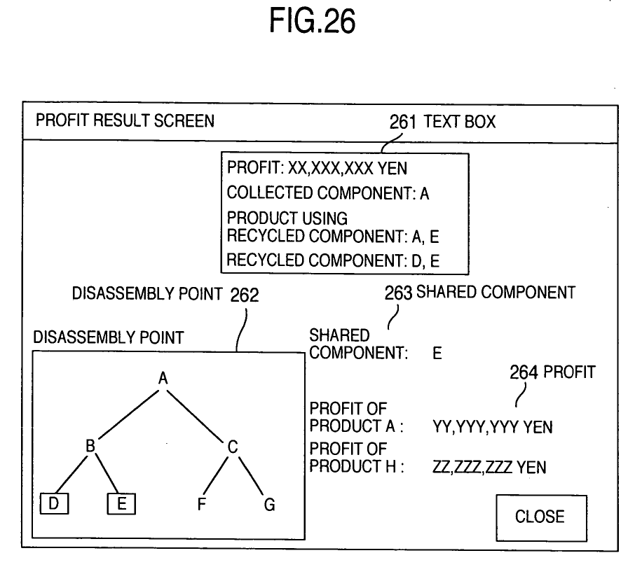

FIG. 25 is a diagram showing an example of the screen displaying a list of the profits of candidate products calculated by the above-described processes of this embodiment. FIG. 26 is a diagram showing an example of the screen displayed when one of the candidates in the list shown in FIG. 25 is selected and a detail button is depressed. These screens will be described next.

A list of the profits of the candidate products shown in FIG. 25 is displayed by sorting the products in the order of higher profit. A user can pay attention to the higher profit. By selecting one candidate and depressing a detail button, the profit screen is displayed as shown in FIG. 26.

A text box 261 shown in FIG. 26 indicates the total profit, products to be collected, products using components of the collected products and recycled components. The disassembly point 262 shown in FIG. 26 is indicated by emphatically displaying the components on the tree of the component constitution. A shared component 263 shown in FIG. 26 is the component capable of being used by a plurality of products among recycled components. Profits 264 shown in FIG. 26 indicate a profit of each product unit using recycled components in the text box 261.

Each process of this embodiment may be constituted of a program. This program may be supplied by storing it in a storage medium such as HD, DAT, FD, MO, DVD-ROM and CD-ROM or via a communication line.

Next, description will be made on a specific example of using the “weight” as the condition of calculating the disassembly point and profit.

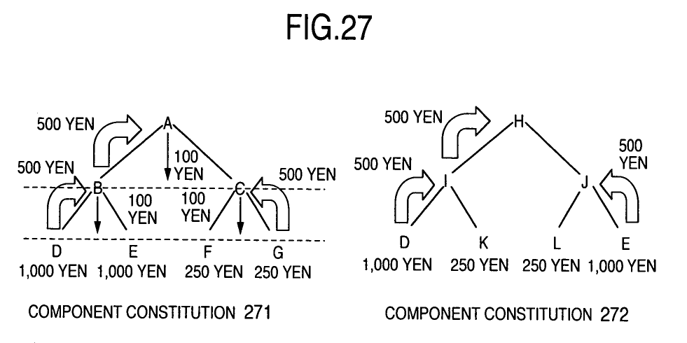

Consider now that the collected product A is disassembled to what level to use its recycled component for the products A and H. It is also considered that the collected product A is disassembled to what level if the period while the recycled component is stored in a warehouse is 3 days or 30 days. The component constitutions of the products A and B are assumed to be those shown in FIG. 27 which have been already described with reference to FIG. 1. The component constitution 271 shown in FIG. 27 is for the product A and indicates the component unit price, assembly cost and disassembly cost. Similarly, the component constitution 272 shown in FIG. 27 is for the product H and indicates the component unit price and assembly cost. The preconditions are as follows.

1. The product A is required that the recycled component should have the weight 10% or more relative to the weight of the product A.

2. The product A satisfies the condition 1 if the component B or the components D and E are used as the recycled components.

3. The products A and H have the component constitutions shown in FIG. 27. The prices shown in FIG. 27 are the unit price, a disassembly cost and an assembly cost.

4. The products A and H are sold both at 10,000 Yen.

5. The collection cost of the product A is 100 Yen per one product.

6. The inspection cost of each component is all 10 Yen per one component.

7. The washing cost of each component is all 10 Yen per one component.

8. The maintenance cost of each component is all 20 Yen per one component.

9. If the recycled components are used, the sales cost of the product lowers 10% and the sales quantity increases 1.2 times.

10. The product A is used as the product to be collected.

11. The defective factor for the collected products A is 5%.

12. The production plan of the product A is 100 products and that of the product H is 100 products.

Under the described conditions, two proposals are used.

(Proposal #1) The product A is disassembled into the component B which is used as the component to be recycled.

(Proposal #2) The product A is disassembled into the components D and E which are used as the components to be recycled. In this case, the components D and E are used for the product H.

For the two proposals, the periods of 3 days and 30 days for storing the components in a warehouse are applied.

<If the Components are Required to be Stored in a Warehouse for 3 Days>

[The Case of the Proposal #1]

Since the components disassembled are only the component B, the product A is collected only as many as the production plan of the product A. Considering the defective factor of 5%,
(the number of products A to be collected)=100×(1−5/100))=105.26

By rounding off 105.26, one hundred and six products are required to be collected.

The cost involved in collecting the products and assembling the component to the product is:
(collection cost+disassembly cost+inspection cost+washing cost+maintenance cost)=(106×100)+(106×100)+(106×10)+(100×10)+(100×20×3)=10,600+10,600+1,060+1,000+6,000=29,260 (Yen)
(the manufacture cost of the product A)=(manufacture quantity)×(assembly cost)=100×1,500=150,000 (Yen)
(the manufacture cost of the product H)=(manufacture quantity)×(assembly cost)=100×4,000=400,000 (Yen)
(total manufacture cost)=579,260 (Yen)
(sales price of A and H)=2,000,000 (Yen) Profit=(sales price of A and H)−(total manufacture cost)=2,000,000−579,260=1,420,740 (Yen)
[The Case of the Proposal #2]

The recycled components are used also for the product H and the product H is not collected. In this case, since the sales quantity increases 1.2 times, the sales quantity of the product H is 120. The two hundred and twenty of the products A and H are manufactured in total. Considering the defective factor of 5%,
(the number of products A to be collected)=220×(1/(1−5/100)))=231.57

By rounding off 231.57, two hundred and thirty tow products are required to be collected.

The cost involved in collecting the products and assembling the components D and E to the products is:
(collection cost+disassembly cost+inspection cost+washing cost+maintenance cost)=(232×100)+(232×200)+(232×10×2)+(220×10×2)+(220×2×20×3)=23,200+46,400+4,640+4,400+26,400=105,040 (Yen)
(the manufacture cost of the product A)=(manufacture quantity)×(assembly cost)=100×2,000=200,000 (Yen)
(the manufacture cost of the product H)=(manufacture quantity)×(assembly cost)=120×2,000=240,000 (Yen)
(total manufacture cost)=545,040 (Yen)
(sales price of A)=100×10,000=1,000,000 (Yen)
(sales price of H)=120×9,000=1,080,000 (Yen)
(sales price of A and H)=2,080,000 (Yen) Profit=(sales price of A and H)−(total manufacture cost)=2,080,000−545,040=1,534,960 (Yen)

Therefore, the proposal #2 is better.

<If the Components are Required to be Stored in a Warehouse for 30 Days>

[The Case of the Proposal #1]
(collection cost+disassembly cost+inspection cost+washing cost+maintenance cost)=(106×100)+(106×100)+(106×10)+(100×10)+(100×20×30)=10,600+10,600+1,060+1,000+60,000=83,260 (Yen)
(the manufacture cost of the product A)=(manufacture quantity)×(assembly cost)=100×1,500=150,000 (Yen)
(the manufacture cost of the product H)=(manufacture quantity)×(assembly cost)=100×4,000=400,000 (Yen)
(total manufacture cost)=633,260 (Yen)
(sales price of A and H)=2,000,000 (Yen) Profit=(sales price of A and H)−(total manufacture cost)=2,000,000−633,260=1,366,740 (Yen)
[The Case of the Proposal]
(collection cost+disassembly cost+inspection cost+washing cost+maintenance cost)=(232×100)+(232×200)+(232×10×2)+(200×10×2)+(220×2×20×30)=23,200+46,400+4,640+4,400+240,000=318,640 (Yen)
(the manufacture cost of the product A)=(manufacture quantity)×(assembly cost)=100×2,000=200,000 (Yen)
(the manufacture cost of the product H)=(manufacture quantity)×(assembly cost)=120×2,000=240,000 (Yen)
(total manufacture cost)=758,640 (Yen)
(sales price of A)=100×10,000=1,000,000 (Yen)
(sales price of H)=120×9,000=1,080,000 (Yen)
(sales price of A and H)=2,080,000 (Yen) Profit=(sales price of A and H)−(total manufacture cost)=2,080,000−758,640=1,321,360 (Yen)

In this case, the proposal #1 is better.

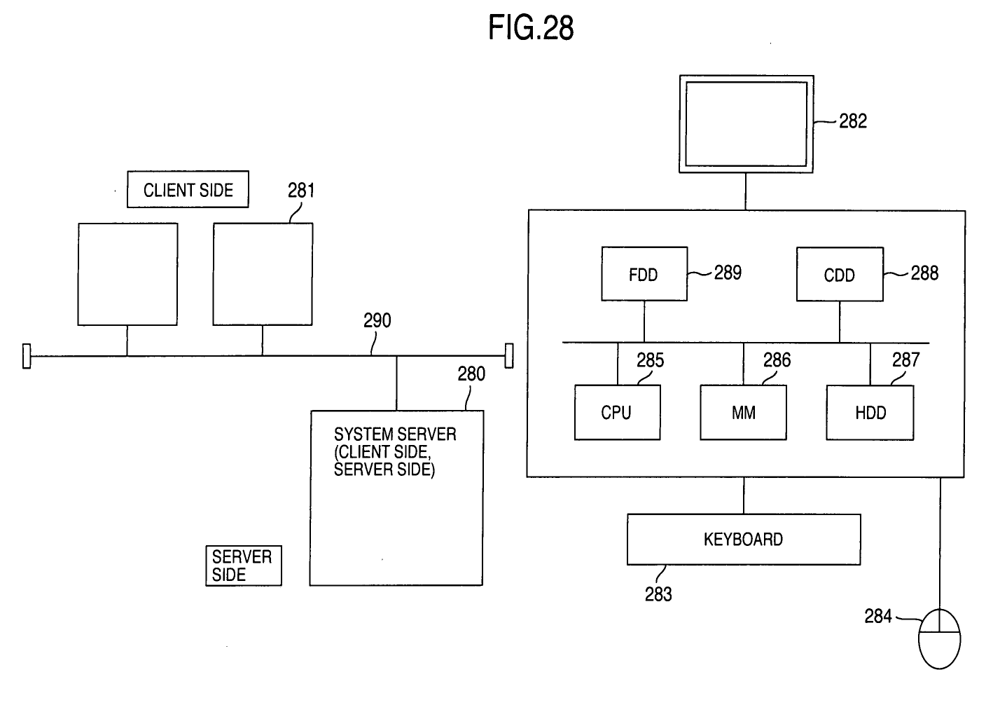

FIG. 28 is a block diagram showing the structure of a recycle supporting system realizing the recycle supporting method of the embodiment. In FIG. 28, reference numeral 280 represents a system server, reference numeral 281 represents a client, reference numeral 282 represents a display, reference numeral 283 represents a keyboard, reference numeral 284 represents a mouse, reference numeral 285 represents a CPU, reference numeral 286 represents a main memory (MM), reference numeral 287 represents a hard disc drive (HDD), reference numeral 288 represents a CD drive (CDD), reference numeral 289 represents a flexible disc drive (FDD) and reference numeral 290 represents a communication line.

As shown in FIG. 28, the recycle supporting system of the embodiment is structured by the system server 280 and a plurality of clients 281 interconnected by the communication line 290 such as a LAN and a public communication network. The system server 280 can also be used as a client, and is provided with an application server function for executing each process of the embodiment described earlier.

As shown in FIG. 28, the system server 280 and client 281 each constituted of: CPU 285 for controlling the entirety of the apparatus; the main memory 286 for storing programs, data and the like usable by CPU; the hard disc drive 287, CD drive 288 and flexible disc drive 289 as an external storage device; the keyboard 286 and mouse 284 as an input device; and the display 282. The screen control for images of this embodiment is executed for the display of the client 281, by making CPU execute the programs stored in the memory of the system server 280. Each process described with reference to the flow charts is also executed by making CPU execute the programs stored in the memory of the system server 280.

When the client accesses the system server 280 for the first time, the system server reads a master file storing various master data and develops all the production plans on the memory, basing upon the contents registered in the master file. Thereafter, the system server 280 executes the calculation requested by the client by reading information from the memory, and displays the execution results on the display of the client. Since this embodiment uses multi clients interconnected by the network, Java (registered trademark) languages or the like can be used as software. Any language may be implemented for the process of reading the master file and developing the production plans on the memory.

Since the recycle supporting system of this embodiment is constituted of one system server 280 and a plurality of clients 281, the screen control for images and various calculation processes requested by a plurality of clients can be executed at the same time, and the execution results can be supplied to the clients. The functions of the system server and client may be realized by one computer. In this case, the calculation results by the system server is displayed on its computer.

In the description of this embodiment, although one of the conditions “weight”, “quantity” and “price” is designated as the initial condition of calculating a profit, a combination of the conditions may be used.

In the description of this embodiment, recycle components satisfying the condition are displayed first, and the profit to be obtained by using the selected recycle component is calculated. The system may be operated in a batch manner to present the largest profit among all candidate recycle components and their combinations. As the screen for displaying the optimum results, the screen shown in FIG. 26 can be used.

According to the invention, not only the profit is increased by using a recycle component, but also the large profit can be obtained while obeying the regulations of laws which obligate to use recycle components. The method and system capable of judging to which level the collected product is disassembled into recycle components can be provided. According to the embodiment, candidate recycle components under the determined condition are displayed, and the recycle component is selected from the candidates to make the system calculate and compare the profits of actual production plans.

Although the fundamental operation is to display candidate components under the designated condition, make a user to select a desired component and calculate a profit, the system of this embodiment may be operated in a batch manner to automatically calculate the largest profit among all candidate components and their combinations and present the calculation results.

It should be further understood by those skilled in the art that although the foregoing description has been made on embodiments of the invention, the invention is not limited thereto and various changes and modifications may be made without departing from the spirit of the invention and the scope of the appended claims.

1. A recycle supporting method comprising steps of:
storing beforehand cost data, data of a production plan and data of a component constitution of a product in a computer, the cost data being involved in disassembling a recycled product and manufacturing a new product, including a component unit price, an assembly cost, a disassembly cost, a collection cost, an inspection cost, a washing cost and a maintenance cost; making said computer determine a disassembly point of components of a collected product in accordance with input information of the collected product and a recycle condition, the data of the component constitution of the product; and
making said computer calculate a profit of the product using a recycled component from said determined disassembly point, said data of the production plan and said cost data.

2. The recycle supporting method according to claim 1, wherein said recycle condition is a condition that of the components of the collected products, recycled components are required to occupy what % of a weight of the new product.

3. The recycle supporting method according to claim 1, wherein said recycle condition is a condition that of the components of the collected products, a predetermined number of recycled components are required to be used.

4. The recycle supporting method according to claim 1, wherein said recycle condition is a condition that of the components of the collected products, recycled components having a component unit price equal to or higher than a predetermined price are required to be used.

5. The recycle supporting method according to claim 1, wherein calculating said profit is executed by disassembling said collected product into components at the assembly point, calculating a cost for making said components be recycled, from said cost data, calculating a manufacture cost of the product using said recycled component, and calculating a difference between a sales price of the product and a sum of said cost and said manufacture cost.

6. A recycle supporting apparatus wherein:
a computer stores cost data, data of a production plan and data of a component constitution of a product, the cost data being involved in disassembling a recycled product and manufacturing a new product, including a component unit price, an assembly cost, a disassembly cost, a collection cost, an inspection cost, a washing cost and a maintenance cost;
determines determine a disassembly point of components of a collected product in accordance with input information of the collected product and a recycle condition, the data of the component constitution of the product; and
calculates and presents a profit of the product using a recycled component from said determined disassembly point, said data of the production plan and said cost data.

7. The recycle supporting apparatus according to claim 6, wherein said recycle condition is a condition that of the components of the collected products, recycled components are required to occupy what % of a weight of the new product.

8. The recycle supporting apparatus according to claim 6, wherein said recycle condition is a condition that of the components of the collected products, a predetermined number of recycled components are required to be used.

9. The recycle supporting apparatus according to claim 6, wherein said recycle condition is a condition that of the components of the collected products, recycled components having a component unit price equal to or higher than a predetermined price are required to be used.

10. The recycle supporting apparatus according to claim 6, wherein calculating said profit is executed by disassembling said collected product into components at the assembly point, calculating a cost for making said components be recycled, from said cost data, calculating a manufacture cost of the product using said recycled component, and calculating a difference between a sales price of the product and a sum of said cost and said manufacture cost.

11. A recycle supporting program comprising steps of:
receiving input information of a product to be connected and a recycle condition;
determining a disassembly point of components of said product to be collected, in accordance with said received input information of said product to be collected and said recycle condition, and prestored data of a component constitution of said product to be collected;
calculating a cost involved in disassembling said product to be collected into components at the disassembly point and making the components capable of being recycled, from cost data involved in disassembling said product to be collected and manufacturing a new product using a disassembled component, the cost data including a component unit price, an assembly cost, a disassembly cost, an inspection cost, a washing cost and a maintenance cost;
calculating a manufacture cost of manufacturing a product using a recycled component from said cost data;
calculating a profit from the manufacture cost of manufacturing the product using said recycled component and the cost involved in making the components usable; and
displaying the calculated profit,
wherein each step is executed by a computer to support recycling.

12. The recycle supporting program according to claim 11, wherein said recycle condition is a condition that of the components of the collected products, recycled components are required to occupy what % of a weight of the new product.

13. The recycle supporting program according to claim 11, wherein said recycle condition is a condition that of the components of the collected products, a predetermined number of recycled components are required to be used.

14. The recycle supporting program according to claim 11, wherein said recycle condition is a condition that of the components of the collected products, recycled components having a component unit price equal to or higher than a predetermined price are required to be used.

15. The recycle supporting apparatus according to claim 11, wherein calculating said profit is executed by disassembling said collected product into components at the assembly point, calculating a cost for making said components be recycled, from said cost data, calculating a manufacture cost of the product using said recycled component, and calculating a difference between a sales price of the product and a sum of said cost and said manufacture cost.

16. A recycle supporting method comprising steps of:
comparing a first type of data regarding cost of a plurality of first type components interconnected via points to a product to be collected, with a second type of data regarding cost of some components which are said first type components capable of being disassembled from said product to be collected and are used by a product recycling said some components as a second type of components;
storing data regarding cost of manufacture of said product recycling said some components in a computer in accordance with a result of said comparing step, said product including said some components; and
making said computer calculate a point among said interconnected points, in case that said data regarding cost of said plurality of first type components is smaller than said data regarding cost of manufacture of said product, in accordance with said first and second types of data, data of a ratio of the second type of components used by said product recycling said some components to all components and the result of said comparing step, said point separating components used as said second type of components from components not used as said second type of components, in said product to be collected.

17. A recycle supporting method according to claim 16, further comprising a step of calculating a profit to be obtained when a product recycling a component used by said product to be collected, is manufactured, said profit being calculated in accordance with said calculated point to be separated and said second type of data, wherein said second type of data includes the number of products to be manufactured.
